(19) United States
(12) Patent Application Publication
(10) Pub. No.: US 2024/0249217 A1
(43) Pub. Date: Jul. 25, 2024

(54) HOUSEWORK POINT CALCULATION METHOD, INFORMATION PROCESSING DEVICE, AND COMPUTER-READABLE RECORDING MEDIUM RECORDING A PROGRAM

(71) Applicant: Panasonic Intellectual Property Corporation of America, Torrance, CA (US)

(72) Inventors: Masataka UEMURA, Nara (JP); Atsushi NISHIMURA, Osaka (JP); Hirokazu KITO, Osaka (JP)

(73) Assignee: Panasonic Intellectual Property Corporation of America, Torrance, CA (US)

(21) Appl. No.: 18/626,943

(22) Filed: Apr. 4, 2024

Related U.S. Application Data
(63) Continuation of application No. PCT/JP2022/037583, filed on Oct. 7, 2022.

(30) Foreign Application Priority Data
Oct. 7, 2021 (JP) 2021-165640
Oct. 7, 2021 (JP) 2021-165642

(51) Int. Cl. G06Q 10/0631

(52) U.S. Cl. CPC G06Q 10/063114

(57) ABSTRACT

An information processing device performs: acquiring use information indicating a use situation of an appliance or a facility; collecting household job data of each of a plurality of users on the basis of the use information; acquiring user coefficient information indicating a user coefficient for each of the users; and calculating, on the basis of the household job data and the user coefficient information, a household job point that is commensurate with a household job amount of each of the users.

### FIELD OF INVENTION

The present disclosure relates to a household job point calculation method, an information processing device, and a computer-readable recording medium recording a program.

### BACKGROUND ART

Patent Literature 1 discloses a user management method including expressing a full use level in connection with an appliance at a numeric value and providing a user having a higher full use level with a predetermined service to give the user an incentive to make full use of the appliance.

However, the user management method disclosed in Patent Literature 1 fails to consider appropriately giving a household job point that is commensurate with a household job amount to a user with the aim of giving the user an incentive to do a household job.

Patent Literature 1: Japanese Patent Publication No. 6161624

### SUMMARY OF THE INVENTION

This disclosure has an object of providing a household job point calculation method, an information processing device, and a computer-readable recording medium recording a program for appropriately giving a user a household job point that is commensurate with a household job amount of the user.

A household job point calculation method according to one aspect of the present disclosure includes: by an information processing device, acquiring use information indicating a use situation of an appliance or a facility; collecting household job data of each of a plurality of users on the basis of the use information; acquiring user coefficient information indicating a user coefficient for each of the users; and calculating, on the basis of the household job data and the user coefficient information, a household job point that is commensurate with a household job amount of each of the users.

A household job point calculation method according to another aspect of the present disclosure includes: by an information processing device, acquiring use information indicating a use situation of an appliance or a facility; collecting household job data of a user on the basis of the use information; acquiring attribute coefficient information indicating an attribute coefficient in connection with an attribute of the user; and calculating, on the basis of the household job data and the attribute coefficient information, a household job point that is commensurate with a household job amount of the user.

### BRIEF DESCRIPTION OF THE DRAWINGS

FIG. 1 is a simplified diagram showing an overall configuration of a home control system in a first embodiment of the present disclosure.

FIG. 2 is a flowchart schematically showing a sequence of a process executed by a controller.

FIG. 3 is a table showing an example of simplified use information.

FIG. 4 is a table showing simplified household job data in a first example.

FIG. 5 is a table showing simplified household job data in a second example.

FIG. 6 is a table showing an example of simplified household job point information generated only on the basis of household job data.

FIG. 7 is a table showing an example of simplified user coefficient information.

FIG. 8 is a table showing an example of simplified household job point information generated on the basis of the household job data and user coefficient information.

FIG. 9 is a flowchart schematically showing a sequence of a process executed by a controller.

FIG. 10 is an illustration of an example of a simplified evaluation input screen image.

FIG. 11 is a table showing an example of management information defining a relationship between a cumulative value of the number of evaluation points and a set value of an evaluation coefficient.

FIG. 12 is a simplified diagram showing an overall configuration of a home control system in a third embodiment of the present disclosure.

FIG. 13 is a flowchart schematically showing a sequence of a process executed by a controller.

FIG. 14 is a table showing an example of simplified attribute coefficient information.

FIG. 15 is a table showing an example of simplified household job point information generated on the basis of household job data and attribute coefficient information.

FIG. 16 is a schematic view of another feature of the disclosure.

### DETAILED DESCRIPTION

Knowledge forming the basis of the present disclosure

A group, such as a family, involves jobs like household jobs to be shared and executed among a plurality of users. In a general family, it is difficult to accumulate a household job amount about the household job execution by each of the users as data, and thus, the amount is less likely to be visualized. Under the circumstances without the visualization of the household job amount, each user can grasp only his/her own household job amount, and thus, the users may feel stress resulting from distrust or unfairness thereamong. An improvement in the visualization of the household job amount is expected to reduce the stress feeling of each user. The improvement in the visualization of the household job amount is further expected to give each user a reward that is commensurate with the household job amount of the user as a household job point, resulting in exerting an effect of giving the user an incentive to do the household job.

By contrast, invisible or unnoticeable jobs still exist even after the improvement in the visualization of the household job amount, and such invisible household jobs are often executed by a specific user. Under the circumstances, a countermeasure is further required to reduce stress feeling of the specific user that is less likely to be reduced only with the improvement in the visualization of the household job amount.

To overcome the drawbacks, the present inventors have obtained the knowledge that a household job point that is commensurate with a household job amount of a user can be appropriately given to the user by collecting household job data of the user on the basis of use information about an appliance or a facility and calculating the household job point on the basis of the household job data and a user coefficient set in advance for the user. The present inventors have conceived of one feature of the disclosure with this knowledge.

Such a user has an attribute which differs depending on, for example, a gender or a generation. Thus, competition for household job amounts among a plurality of users belonging to a certain attribute other than a family may improve the motivation of each user more effectively than competition for household job amounts among a plurality of users belonging to a family and living together. Specifically, visualization of the household job amount of each user may lead to a reduction in the stress feeling of the user, but may generate new stress feeling under comparison with another user who lives in a different environment.

To overcome the drawbacks, the present inventors have found the necessity of providing, by using an attribute of a user, information encouraging a plurality of users each presumed to live in a similar environment and belong to the same attribute to compete against each other for the household job amount. Then, the inventors further have obtained the knowledge that a household job point that is commensurate with a household job amount and an attribute of a user can be appropriately given to the user by collecting the household job data of the user on the basis of use information about an appliance or a facility, and calculating the household job point on the basis of the household job data and an attribute coefficient set in advance on the basis of the attribute of the user. The present inventors have conceived of another feature of the disclosure with this knowledge.

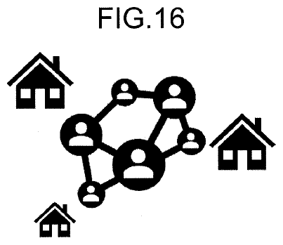

FIG. 16 is a schematic view of another feature of the disclosure. A plurality of users belonging to a plurality of families constitute an area or a community. The users are classified into a plurality of groups in accordance with an attribute, such as a gender or an age. An attribute coefficient in connection with the attribute is set in advance, and a household job point for each user is calculated on the basis of the household job data and the attribute coefficient of each user.

Hereinafter, features of the present disclosure will be described.

A household job point calculation method according to a first feature of the present disclosure includes: by an information processing device, acquiring use information indicating a use situation of an appliance or a facility; collecting household job data of each of a plurality of users on the basis of the use information; acquiring user coefficient information indicating a user coefficient for each of the users; and calculating, on the basis of the household job data and the user coefficient information, a household job point that is commensurate with a household job amount of each of the users.

In the first feature, a household job point that is commensurate with a household job amount of each of the users can be appropriately given to the user.

A household job point calculation method according to a second feature of the disclosure may further include, in the first feature, setting the user coefficient for each of the users on the basis of the household job data of the user in a predetermined period.

The second feature enables appropriate setting of the user coefficient for each of the users on the basis of the household job amount.

With a household job point calculation method according to a third feature of the disclosure, in the second feature, in the setting of the user coefficient, a larger user coefficient may be set for a user having a larger household job amount in the predetermined period.

The third feature achieves an improvement in a motivation of a user having a larger household job amount.

With a household job point calculation method according to a fourth feature of the disclosure, in the second feature, in the setting of the user coefficient, a larger user coefficient may be set for a user having a smaller household job amount in the predetermined period.

The fourth feature achieves an improvement in a motivation of a user having a smaller household job amount.

A household job point calculation method according to a fifth feature of the disclosure may further include, in any one of the first to fourth features, acquiring change information indicating a change in the user coefficient from a specific user of the users, and changing the user coefficient on the basis of the change information.

The fifth feature enables an appropriate change in the user coefficient of each of the users by a specific user.

A household job point calculation method according to a sixth feature of the disclosure may further include, in the fifth feature, setting the specific user on the basis of the household job data of the users in a predetermined period.

The sixth feature permits a user having the largest household job amount in a predetermined period to have a change authority to change the user coefficient.

A household job point calculation method according to a seventh feature of the disclosure may further include, in any one of the first to fourth features, calculating a cumulative household job amount of each of the users, and changing the user coefficient of the user on the basis of the cumulative household job amount of the user.

The seventh feature enables an appropriate change in the user coefficient of each user on the basis of the cumulative household job amount.

A household job point calculation method according to an eighth feature of the disclosure may further include, in any one of the first to fourth features, changing the user coefficient in accordance with a timeframe in which a household job is executed.

The eighth feature enables an appropriate change in the user coefficient of each user in accordance with a timeframe in which a household job is executed.

With a household job point calculation method according to a ninth feature of the disclosure, in any one of the first to eighth features, the use information may further include first use information about use of the appliance or the facility accompanied by execution of a household job, and second use information about use of the appliance or the facility unaccompanied by the execution of the household job, and, in the collecting of the household job data, the household job data may be collected on the basis of the first use information.

The nineth feature enables appropriate collecting of the household job data concerning use of an appliance or a facility by distinguishing use thereof accompanied by execution of the household job and use thereof unaccompanied by the execution of the household job from each other.

A household job point calculation method according to a tenth feature of the disclosure may further include, in any one of the first to nineth features, acquiring evaluation coefficient information indicating an evaluation coefficient in connection with an evaluation of a household job executed by each of the users, and, in the calculating of the household job point, the household job point may be calculated on the basis of the household job data, the user coefficient information, and the evaluation coefficient information.

The tenth feature succeeds in motivating each user to carefully execute the household job in consideration of a possible fluctuation in the household job point thereof depending on evaluation from another user.

A household job point calculation method according to an eleventh feature of the present disclosure includes: by an information processing device, acquiring use information indicating a use situation of an appliance or a facility; collecting household job data of a user on the basis of the use information; acquiring attribute coefficient information indicating an attribute coefficient in connection with an attribute of the user; and calculating, on the basis of the household job data and the attribute coefficient information, a household job point that is commensurate with a household job amount of the user.

In the eleventh feature, a household job point that is commensurate with a household job amount and an attribute of the user can be appropriately given to the user.

A household job point calculation method according to a twelfth feature of the disclosure may further include, in the eleventh feature, setting an attribute coefficient for each of a plurality of users on the basis of household job data of the users in a predetermined time period, the users belonging to a specific same category of a plurality of categories included in the attribute.

The twelfth feature enables the users belonging to the same category to compete against each other for the household job amount.

With a household job point calculation method according to a thirteenth feature of the disclosure, in the twelfth feature, in the setting of the attribute coefficient, a larger attribute coefficient may be set for a user having a larger household job amount in the predetermined period.

The thirteenth feature achieves an improvement in a motivation of a user having a larger household job amount.

With a household job point calculation method according to a fourteenth feature of the disclosure, in the twelfth feature, in the setting of the attribute coefficient, a larger attribute coefficient may be set for a user having a smaller household job amount in the predetermined period.

The fourteenth feature achieves an improvement in a motivation of a user having a smaller household job amount.

A household job point calculation method according to a fifteenth feature of the disclosure may further include, in the eleventh feature, setting an attribute coefficient for each of a plurality of categories included in the attribute, and, in the setting of the attribute coefficient, an identical attribute coefficient may be set for a plurality of users belonging to a specific same category.

The fifteenth feature enables competition for household job amounts among a plurality of categories included in the attribute.

With a household job point calculation method according to a sixteenth feature of the disclosure, in any one of the eleventh to fifteenth features, the attribute coefficient information may include a plurality of attribute coefficients in connection with a plurality of kinds of attributes.

The sixteenth feature enables setting of attribute coefficients from various perspectives in consideration of a plurality of kinds of attributes.

With a household job point calculation method according to a seventeenth feature of the disclosure, in the sixteenth feature, in the calculating of the household job point, two or more attribute coefficients of the attribute coefficients may be used in combination.

The seventeenth feature enables setting of the attribute coefficient on the basis of a plurality of attributes.

With a household job point calculation method according to an eighteenth feature of the disclosure, in the sixteenth feature, in the calculating of the household job point, one attribute coefficient selected from the attribute coefficients may be used.

The eighteenth feature enables setting of the attribute coefficient on the basis of an optimal attribute.

A household job point calculation method according to a nineteenth feature of the disclosure may further include, in any one of the eleventh to eighteenth feature, acquiring change information indicating a change in the attribute coefficient from a specific user, and changing the attribute coefficient on the basis of the change information.

The nineteenth feature enables an appropriate change in an attribute coefficient of a user by the specific user.

A household job point calculation method according to a twentieth feature of the disclosure may further include, in the nineteenth feature, setting the specific user on the basis of household job data of a plurality of users in a predetermined period.

The twentieth feature permits a user having the largest household job amount in a predetermined period to have a change authority to change the attribute coefficient.

A household job point calculation method according to a twenty first feature of the disclosure may further include, in any one of the eleventh to eighteenth features, calculating a cumulative household job amount of each of the users, and changing the attribute coefficient on the basis of the cumulative household job amount of the user.

The twenty first feature enables an appropriate change in the attribute coefficient of the user on the basis of the cumulative household job amount.

A household job point calculation method according to a twenty second feature of the disclosure may further include, in any one of the eleventh to eighteenth features, changing the attribute coefficient in accordance with a timeframe in which a household job is executed.

The twenty second feature enables an appropriate change in the attribute coefficient of the user in accordance with a timeframe in which a household job is executed.

With a household job point calculation method according to a twenty third feature of the disclosure, in any one of the eleventh to twenty second features, the use information may include first use information about use of the appliance or the facility accompanied by execution of a household job, and second use information about use of the appliance or the facility unaccompanied by the execution of the household job, and, in the collecting of the household job data, the household job data may be collected on the basis of the first use information.

The twenty third feature enables appropriate collecting of the household job data concerning use of an appliance or a facility by distinguishing use thereof accompanied by execution of the household job and use thereof unaccompanied by the execution of the household job from each other.

An information processing device according to a twenty fourth feature of the present disclosure includes: an acquisition part; and a processing part. The acquisition part acquires use information indicating a use situation of an appliance or a facility, the processing part collects household job data of each of users on the basis of the use information, the acquisition part acquires user coefficient information indicating a user coefficient for each of the users, and the processing part calculates, on the basis of the household job data and the user coefficient information, a household job point that is commensurate with a household job amount of each of the users.

In the twenty fourth feature, a household job point that is commensurate with a household job amount of each of the users can be appropriately given to the user.

An information processing device according to a twenty fifth feature of the present disclosure includes: an acquisition part; and a processing part. The acquisition part acquires use information indicating a use situation of an appliance or a facility, the processing part collects household job data of a user on the basis of the use information, the acquisition part acquires attribute coefficient information indicating an attribute coefficient in connection with an attribute of the user, and the processing part calculates, on the basis of the household job data and the attribute coefficient information, a household job point that is commensurate with a household job amount of the user.

In the twenty fifth feature, a household job point that is commensurate with a household job amount and an attribute of the user can be appropriately given to the user.

A computer-readable recording medium recording a program according to a twenty sixth feature of the present disclosure causing an information processing device to serve as an acquisition part and a processing part. The acquisition part acquires use information indicating a use situation of an appliance or a facility, the processing part collects household job data of each of a plurality of users on the basis of the use information, the acquisition part acquires user coefficient information indicating a user coefficient for each of the users, and the processing part calculates, on the basis of the household job data and the user coefficient information, a household job point that is commensurate with a household job amount of each of the users.

In the twenty sixth feature, a household job point that is commensurate with a household job amount of each of the users can be appropriately given to the user.

A computer-readable recording medium recording a program according to a twenty seventh feature of the present disclosure causing an information processing device to serve as an acquisition part and a processing part. The acquisition part acquires use information indicating a use situation of an appliance or a facility, the processing part collects household job data of a user on the basis of the use information, the acquisition part acquires attribute coefficient information indicating an attribute coefficient in connection with an attribute of the user, and the processing part calculates, on the basis of the household job data and the attribute coefficient information, a household job point that is commensurate with a household job amount of the user.

In the twenty seventh feature, a household job point that is commensurate with a household job amount and an attribute of the user can be appropriately given to the user.

This disclosure can be realized as a program for causing a computer to execute each distinctive feature included in such a method or a device described above, or realized as a system caused to operate by the program. Additionally, it goes without saying that the computer program is distributable as a non-transitory computer readable storage medium like a CD-ROM, or distributable via a communication network like the Internet.

### Embodiments of the Present Disclosure

Hereinafter, embodiments of the disclosure will be described with reference to the accompanying drawings. The elements given the same reference numerals in different drawings are defined to be the same or corresponding elements. Further, constituent elements, arrangement and connection of the constituent elements, an operation order, and the like shown in the embodiments described below are mere examples, and do not intend to limit the present disclosure. The present disclosure is defined by the scope of claims. Moreover, constituent elements which are not recited in the independent claims each showing the broadest concept among the constituent elements in the embodiments are not indispensable to achieve the object of the present disclosure but are described as selectable constituent elements.

### First Embodiment

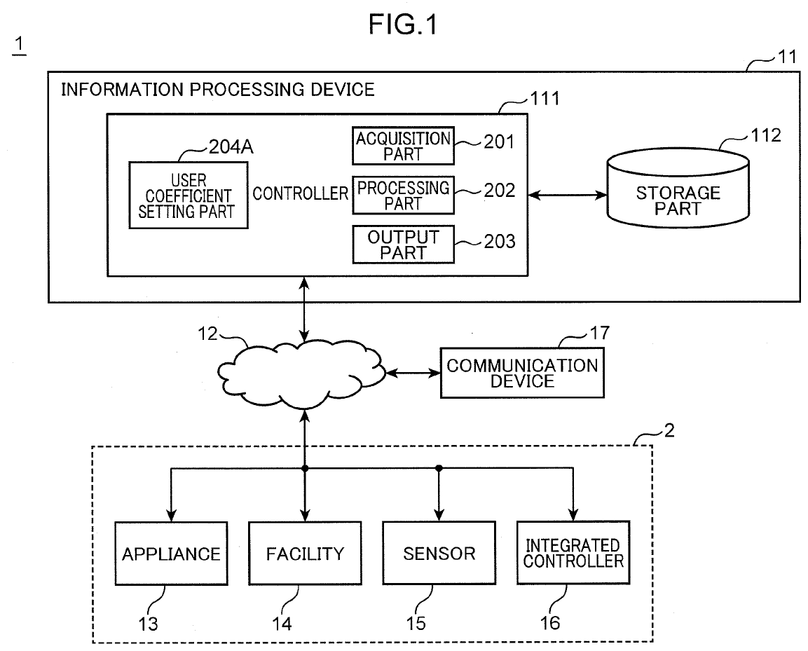

FIG. 1 is a simplified diagram showing an overall configuration of a home control system 1 in a first embodiment of the present disclosure. The home control system 1 includes a smart home 2, a communication network 12, an information processing device 11, and a communication device 17. Although FIG. 1 shows only one smart home 2 for simplified explanation, a plurality of smart homes 2 may be included. The present disclosure is applicable to an indoor facility, such as an office, a restaurant, and a commercial facility, without limitation to a residence like the smart home 2. This disclosure may be further applicable to a space including an indoor space and an outdoor space without limitation to such an indoor facility.

The smart home 2 includes a plurality of spaces or rooms including a room or chamber, a bathroom, a toilet room, an entrance, and a hallway, where a plurality of appliances 13 and a plurality of facilities 14 are arranged. The appliances 13 include an electric cooker, a refrigerator, a washing machine, and a toilet cleansing device. The facilities 14 include water supply equipment, like a tap or a faucet, and a shower device, provided in a kitchen or the bathroom.

The smart home 2 is provided with a plurality of sensors 15. The sensors 15 include a microphone, an infrared sensor, an ultrasonic sensor, a fingerprint sensor, an iris sensor, or a camera. Each sensor 15 may be included in the appliance 13 or the facility 14, or may be provided independently of the appliance 13 or the facility 14. The sensor 15 detects an execution situation of a household job in the smart home 2, and sends sensing information obtained through the detection to the information processing device 11 via the communication network 12. The sensing information includes information for specifying a user using the appliance 13 or the facility 14. For instance, when the sensor 15 is a camera, the sensing information includes image data of the user captured by the camera. The information processing device 11 or the sensor 15 may specify the user on the basis of the sensing information. When operating information 22 to be described later includes user information 23 in accordance with a preliminary input of a user ID in use of the appliance 13 or the facility 14, the acquisition of the sensing information from the sensor 15 is excludable.

The smart home 2 is further provided with an integrated controller 16 to control an operation of an appliance 13 or a facility 14 to be controlled among the appliances 13 or the facilities 14. The integrated controller 16 can perform data communication with the appliance 13 or the facility 14 to be controlled via the communication network 12 or a wireless LAN in the smart home 2.

The communication device 17 includes smart phones respectively owned by users living in the smart home 2.

The information processing device 11 includes a cloud server or an edge server to manage an entirety of the home control system 1. The information processing device 11 can perform data communication with the communication device 17, the integrated controller 16, the appliance 13, the facility 14, or the sensor 15 via the communication network 12. The integrated controller 16 may include the functions of the information processing device 11.

The information processing device 11 includes a controller 111 and a storage part 112.

The controller 111 includes a processor, such as a CPU. The storage part 112 includes an HDD, an SSD, a flush memory, or other memory.

The controller 111 operatively includes an acquisition part 201, a processing part 202, an output part 203, and a user coefficient setting part 204A each coming into effect when the CPU executes a program read to the ROM or the RAM from the storage part 112. In other words, the program causes the information processing device 11 to serve as the acquisition part 201, the processing part 202, the output part 203, and the user coefficient setting part 204A.

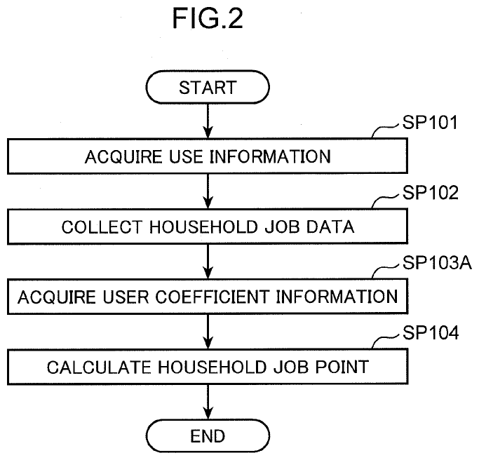

FIG. 2 is a flowchart schematically showing a sequence of a process executed by the controller 111.

First, in step SP101, the acquisition part 201 acquires use information 20 indicating a use situation of an appliance 13 or a facility 14 from the appliance 13 or the facility 14 via the communication network 12. The use information 20 may be acquired in real time, or at equal time intervals. The acquisition part 201 stores the acquired use information 20 in the storage part 112.

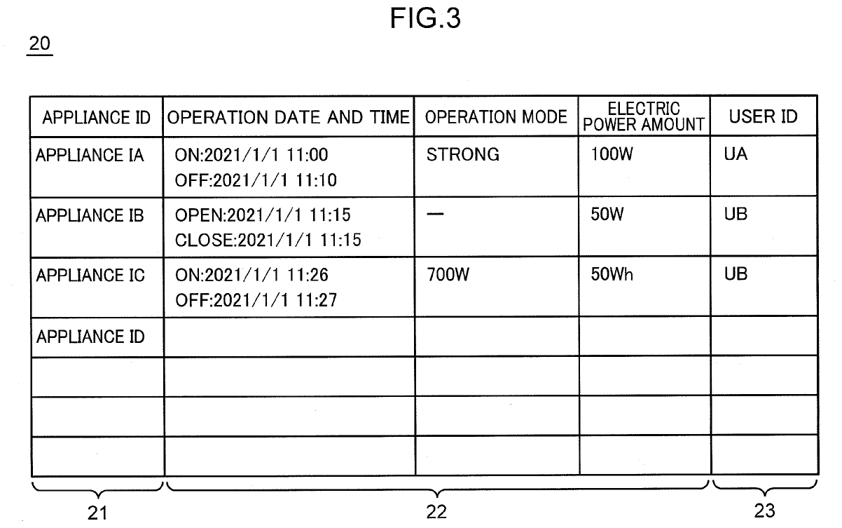

FIG. 3 is a table showing an example of simplified use information 20. The use information 20 includes appliance information 21, the operating information 22, and the user information 23. Although FIG. 3 shows use information 20 about appliances 13, this is similarly applicable to facilities 14.

The appliance information 21 includes an appliance ID for individually identifying each of the appliances 13. In a case where there is only one appliance 13 to be managed, the appliance information 21 may be omitted.

The operating information 22 includes operation date and time information, operation strength information, and setting information at the operation. The operation strength information includes a degree of strength or weakness, or a power consumption amount. The controller 111 may acquire the operation strength information from the appliance 13 or the facility 14, or may calculate the operation strength information on the basis of information acquired from the appliance 13 or the facility 14. For instance, the controller 111 calculates the power consumption amount on the basis of an operating time and an operating wattage. The setting information at the operation includes operation mode information. The operation mode information includes household job mode information (first use information) indicating a household job mode associated with use accompanied by execution of a household job and use mode information (second use information) indicating a use mode associated with use unaccompanied by the execution of the household job. For instance, regarding a shower device in a bathroom, use of the shower device for cleaning the bathroom is directed to the household job mode, and use of the shower device at taking a bath is directed to the use mode. Distinction between the household job mode and the use mode may be made in accordance with an input from the user for a mode setting in use of the appliance 13 or the facility 14, or may be automatically made by the information processing device 11 on the basis of timeframe information or a result of detection from the sensor 15. The use information 20 only about the household job mode of the household job mode and the use mode is collected for use in generating household job data 31, 32 to be described later.

The user information 23 includes a user ID for individually identifying each of the users. Distinction among the users each executing a household job may be received in accordance with an input of a user ID from an associated user in use of the appliance 13 or the facility 14, or may be automatically made by the information processing device 11 on the basis of a result of detection from the sensor 15. Alternatively, the communication device 17 or the integrated controller 16 may be used for a text input or a voice input to receive the input of the user ID after the use.

Subsequently, in step SP102, the processing part 202 collects the household job data 31 of each of the users on the basis of management information defining a correspondence between a kind of the appliance 13 or the facility 14 and a content of a household job and on the basis of the use information 20 acquired in step SP101.

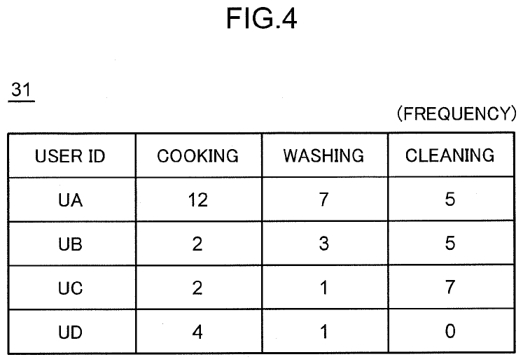

FIG. 4 is a table showing simplified household job data 31 in a first example. In the household job data 31, a household job amount of each of the users in a predetermined period (e.g., one week, one month, or a couple of months) is calculated as a household job execution frequency. The processing part 202 counts one execution frequency when a predetermined time period or longer continuously elapses without use of an appliance 13 or a facility 14 after a finish of the use of the appliance 13 or the facility 14 accompanied by execution of a household job. Examples of the predetermined time period include ten minutes, thirty minutes, and one hour. In detection of use of a certain appliance 13 or a certain facility 14 by a plurality of users in a certain timeframe, the processing part 202 may distribute the execution frequency of a relevant household job to the users. For instance, in detection of one execution frequency of a household job using the same appliance 13 or facility 14 by each of the users UA and UB in the morning, the processing part 202 calculates the execution frequency as ½ for each of the users UA and UB.

In the example shown in FIG. 4, the frequency of cooking may be calculated independently for breakfast, lunch, and supper on the basis of timeframe information. Besides, the frequency of cleaning may be calculated for each room or chamber on the basis of position information about a cleaner. Furthermore, when the household job point is calculated on the basis of household job data in step SP104 to be described later, a coefficient which is different depending on a timeframe may be multiplied, or a coefficient which is different depending on a chamber may be multiplied. For instance, a larger coefficient may be set for a timeframe or a chamber with a smaller execution frequency of the household job.

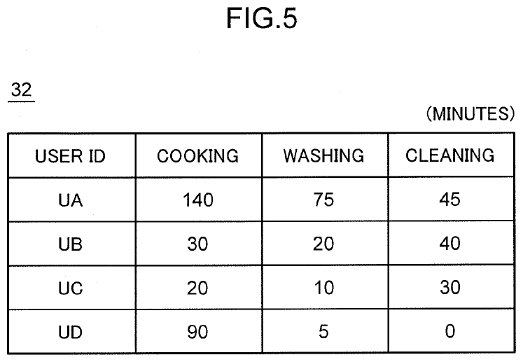

FIG. 5 is a table showing simplified household job data 32 in a second example. In the household job data 32, a household job amount of each of the users is calculated as an execution time (minute) of the household job in a predetermined time period.

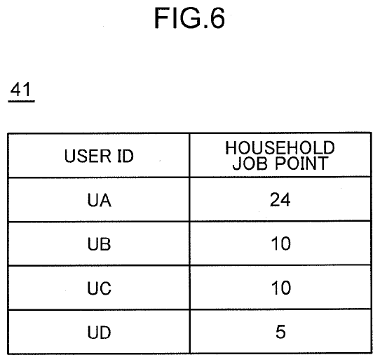

FIG. 6 is a table showing an example of simplified household job point information 41 generated only on the basis of the household job data 31. Regarding the household job point information 41, the household job point for each user is calculated by simple addition of an execution frequency of a household job included in household job data 31 per user.

Subsequently, in step SP103A, the acquisition part 201 acquires, from the storage part 112, user coefficient information 50 indicating a user coefficient for each of the users.

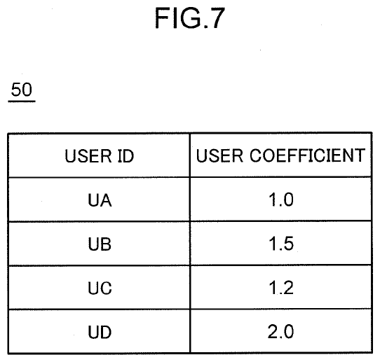

FIG. 7 is a table showing an example of simplified user coefficient information 50. In the example shown in FIG. 7, user coefficients “1.0”, “1.5”, “1.2”, and “2.0” are set respectively for users UA, UB, UC, and UD. The user coefficient setting part 204A sets the user coefficient information 50 in advance. For instance, the user coefficient setting part 204A sets the user coefficient information 50 on the basis of, for example, household job data 31, 32 about a plurality of users in a predetermined period. As a first example, the user coefficient setting part 204A sets a larger user coefficient for a user having a larger household job amount within the most recent one month in accordance with a difference in household job amount. This attains an improvement in a motivation of a user having a larger household job amount. As a second example, the user coefficient setting part 204A may set a larger user coefficient for a user having smaller household job amount within the most recent one month in accordance with a difference in household job amount. This attains an improvement in a motivation of a user having a smaller household job amount. Here, all the users may have different user coefficient values from each other, or a part of the users may have an identical user coefficient value.

Next, in step SP104, the processing part 202 calculates a household job point that is commensurate with a household job amount of each of the users on the basis of the household job data 31 and the user coefficient information 50 to generate household job point information 42.

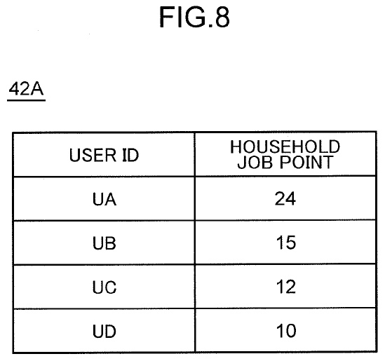

FIG. 8 is a table showing an example of simplified household job point information 42A generated on the basis of the household job data 31 and the user coefficient information 50. Regarding the household job point information 42A, the user coefficient shown in FIG. 7 is multiplied by the household job point included in the household job point information 41 shown in FIG. 6 to calculate the household job point for each user.

The output part 203 outputs the household job point information 42A generated by the processing part 202. The user can obtain privileges described below in accordance with the given household job point.

As a first example, the user can download software from a website of a manufacturer of a specific home appliance which has been already purchased to the home appliance in accordance with the household job point that the user has, and thus can extend the functionality of the home appliance.

As a second example, the user can purchase a new product of software or hardware prior to general release thereof in accordance with the household job point that the user has.

As a third example, the user can try test use of a new product of software or hardware prior to general release thereof in accordance with the household job point that the user has.

In the embodiment, the calculation of the household job point based on the household job data 31 and the user coefficient information 50 leads to achievement in appropriate giving of a household job point that is commensurate with the household job amount of each user to the user.

### First Modification

A user coefficient may be determined or changed by a specific user defined in advance. The specific user having a change authority inputs change information indicating a change content of the user coefficient from a communication device 17 or an integrated controller 16. An acquisition part 201 acquires the change information via a communication network 12. A user coefficient setting part 204A changes the user coefficient on the basis of the change information acquired by the acquisition part 201, and stores the changed user coefficient information 50 in a storage part 112. Thereafter, calculation of a household job point is executed by using the changed user coefficient information 50.

The specific user may change the user coefficient of each user unconditionally or within a range in which a total value of user coefficients of all the users or the household job points for the users reaches an upper limit or lower. For instance, a user coefficient larger than usual may be set for a user having executed a household job in response to an irregular event, such as a sudden visit of an unexpected visitor. The user coefficient setting part 204A may set, as the specific user, a user having the largest household job amount within the most recent predetermined period (e.g., one week, one month, or a couple of months) on the basis of the household job data 31 about the predetermined period. An information processing device 11 may transmit a change notification to a communication device 17 owned by a target user whose user coefficient has been changed to cause the communication device 17 to display, on a screen thereof, such a message as to motivate the user to do the household job.

### Second Modification

A user coefficient may be changed in accordance with a cumulative value of household job data 31, 32. A user coefficient setting part 204A calculates a cumulative household job amount (frequency or time) of each user on the basis of the household job data 31, 32, and changes the user coefficient of each user on the basis of the calculated cumulative amount. The user coefficient setting part 204A further stores the changed user coefficient information 50 in a storage part 112, and thereafter, calculation of the household job point is executed by using the changed user coefficient information 50.

For instance, the user coefficient setting part 204A may set a user coefficient having a first value for household job data having less than a predetermined cumulative household job amount (e.g., ten times), and set a user coefficient having a second value which is larger than the first value for household job data having the predetermined cumulative household job amount or larger. Contrarily, the user coefficient setting part 204A may set a user coefficient having a first value for household job data having less than a predetermined cumulative household job amount, and set a user coefficient having a second value which is smaller than the first value for household job data having the predetermined cumulative household job amount or larger. One of the first value and the second value may be identical among a plurality of users.

### Third Modification

A user coefficient may be changed in accordance with a timeframe in which a household job is executed. A user coefficient setting part 204A specifies, on the basis of timeframe information included in use information 20, a timeframe in which a household job is executed, and changes the user coefficient in accordance with the timeframe.

For instance, the user coefficient setting part 204A may divide twenty four hours in a day into a first timeframe from 0:00 to 12:00, a second timeframe from 12:00 to 18:00, and a third timeframe from 18:00 to 24:00, and then set a user coefficient for each user to a different value depending on the timeframe. For instance, the user coefficient may be set to a larger value in the order of the first timeframe, the second timeframe, and the third timeframe, or the user coefficient may be set to a smaller value in the order of the first timeframe, the second time, and the third timeframe. The user coefficient setting part 204A may set the user coefficient to a different value in accordance with the number of users staying in a smart home 2 for each timeframe. For instance, the user coefficient may be set to a larger value for a smaller number of users staying in the smart home.

### Fourth Modification

A user coefficient may be changed in accordance with a content of a household job. In a case where the number of users having executed a specific household job (which is called a disliked household job) is smaller than a predetermined value within the most recent collecting period of household job data 31, a user coefficient setting part 204A changes the user coefficient of a user having executed the household job to increase by a predetermined value or a predetermined proportion. The user coefficient setting part 204A stores the changed user coefficient information 50 in a storage part 112, and thereafter, executes calculation of a household job point on the basis of the changed user coefficient information 50.

### Second Embodiment

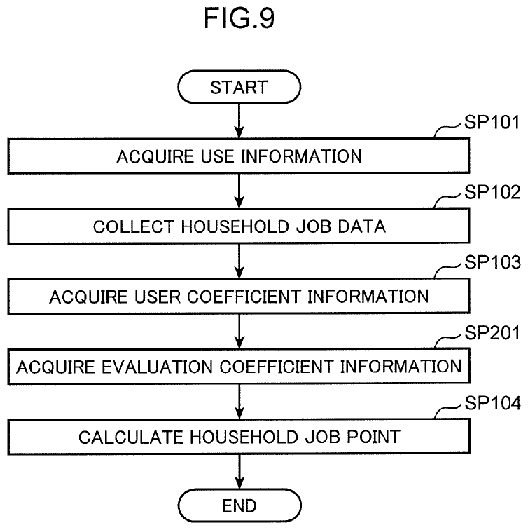

FIG. 9 is a flowchart schematically showing a sequence of a process executed by a controller 111. Hereinafter, differences from the first embodiment will be mainly discussed.

First, in step SP101, an acquisition part 201 acquires use information 20 from an appliance 13 or a facility 14.

Subsequently, in step SP102, a processing part 202 collects household job data 31 of each of a plurality of users.

Next, in step SP103, the acquisition part 201 acquires user coefficient information 50 from a storage part 112.

Subsequently, in step SP201, the acquisition part 201 acquires evaluation coefficient information from the storage part 112. The evaluation coefficient represents an evaluation by another user for a household job executed by a certain user.

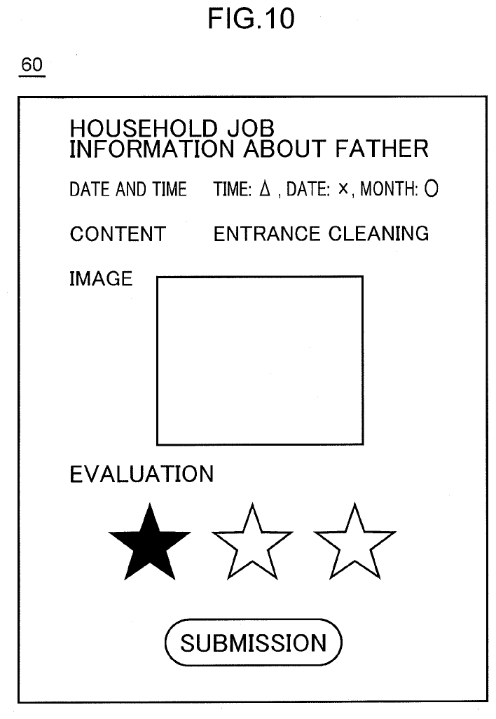

FIG. 10 is an illustration of an example of a simplified evaluation input screen image 60. When a household job is executed by a certain user, an information processing device 11 causes a communication device 17 owned by another user to display the evaluation input screen image 60.

FIG. 10 exemplifies the evaluation input screen image 60 for entrance cleaning executed by a father. The evaluation input screen image 60 shows, as information about the household job executed by the father, an execution date and time, a content, an image of the entrance after the cleaning completion, a three-stage evaluation input item, and a submission button. An entrance camera serving as a sensor 15 captures the image. When another user having input an evaluation to the evaluation input items taps the submission button, resultant information indicating an evaluation point is transmitted from the communication device 17 to the information processing device 11 via a communication network 12. The processing part 202 calculates the number of evaluation points accumulated for each of the users in a current collecting period of household job data 31, and sets an evaluation coefficient in accordance with the cumulative value for each of the users.

The evaluation for the household job executed by a certain user is not limited to a manual input by another user. For instance, the processing part 202 may be configured to calculate a first cleanliness level on the basis of an image of a target area which is to be cleaned, calculate second cleanliness level on the basis of an image of the target area which has been cleaned, calculate a difference value between the first cleanliness level and the second cleanliness level, and give a higher evaluation as the difference value is larger, and then automatically input the evaluation.

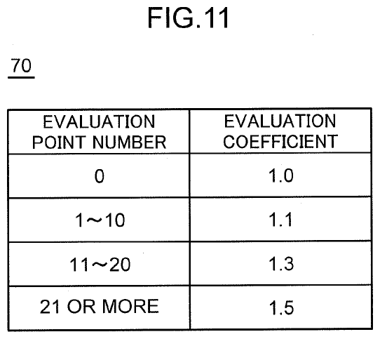

FIG. 11 is a table showing an example of management information 70 defining a relationship between a cumulative value of the number of evaluation points and a set value of an evaluation coefficient. For instance, when the cumulative value of the evaluation point number indicates “0”, the evaluation coefficient has a value of “1.0”. When the cumulative value of the evaluation point number indicates “1 to 10”, the evaluation coefficient has a value of “1.1”. The processing part 202 generates evaluation coefficient information as table information showing a set value of an evaluation coefficient for each of users, and stores the generated evaluation coefficient information in the storage part 112.

Next, in step SP104, the processing part 202 calculates a household job point that is commensurate with a household job amount of each user on the basis of the household job data 31, user coefficient information 50, and the evaluation coefficient information to generate household job point information 42.

In the embodiment, a household job point for one user fluctuates due to an evaluation by another user, and thus, each user is motivated to carefully execute the household job.

### Third Embodiment

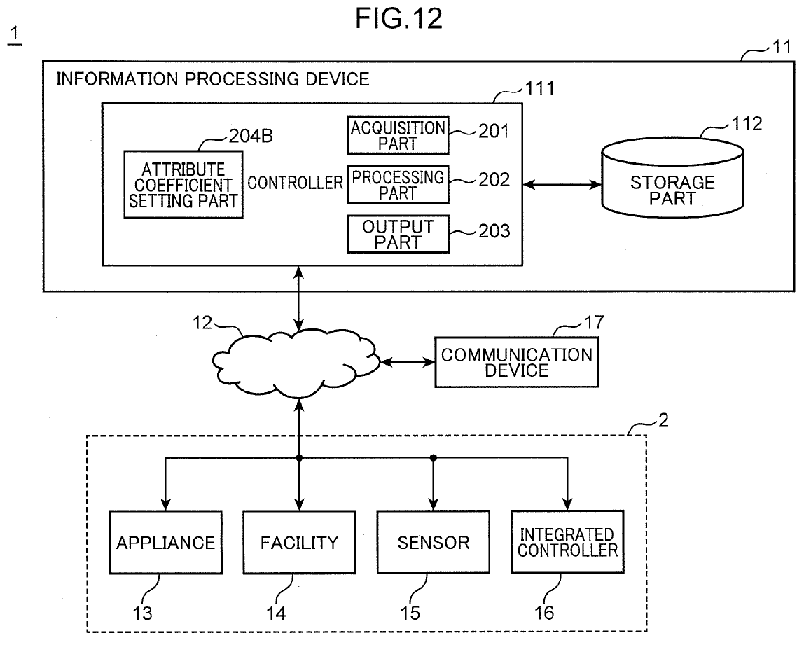

Hereinafter, differences from the first embodiment will be mainly discussed for a third embodiment of the disclosure. FIG. 12 is a simplified diagram showing an overall configuration of a home control system 1 in the third embodiment of the present disclosure.

A controller 111 operatively includes an acquisition part 201, a processing part 202, an output part 203, and an attribute coefficient setting part 204B each coming into effect when a CPU executes a program read to a ROM or a RAM from a storage part 112. In other words, the program causes the information processing device 11 to serve as the acquisition part 201, the processing part 202, the output part 203, and the attribute coefficient setting part 204B.

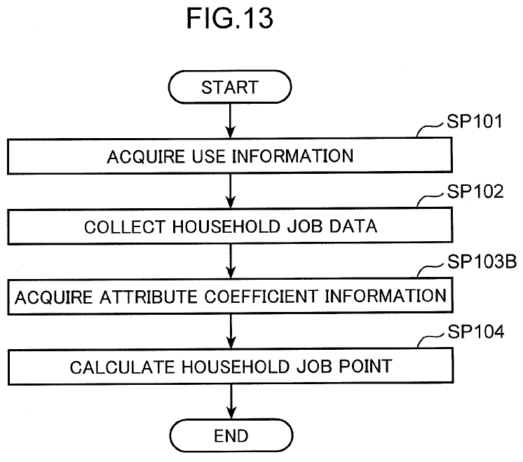

FIG. 13 is a flowchart schematically showing a sequence of a process executed by the controller 111.

First, in step SP101, the acquisition part 201 acquires use information 20 indicating a use situation of an appliance 13 or a facility 14 from the appliance 13 or the facility 14 via a communication network 12 in the same manner as the first embodiment. An example of the use information 20 is similar to that in the first embodiment.

Subsequently, in step SP102, the processing part 202 collects household job data 31 of each of a plurality of users on the basis of management information defining a correspondence between a kind of the appliance 13 or the facility 14 and a content of a household job and on the basis of the use information 20 acquired in step SP101, in the same manner as the first embodiment. An example of the household job data 31 is similar to that in the first embodiment.

Next, in step SP103B, the acquisition part 201 acquires, from the storage part 112, attribute coefficient information 51 indicating an attribute coefficient set on the basis of an attribute of the user.

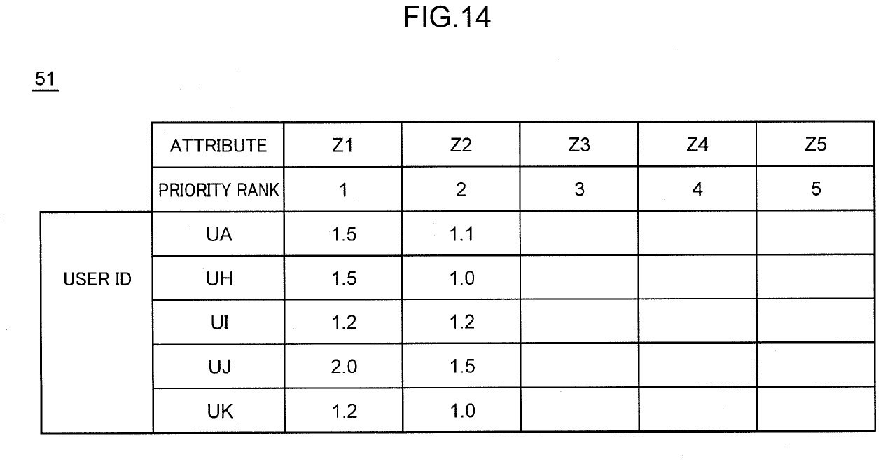

FIG. 14 is a table showing an example of simplified attribute coefficient information 51. The attribute coefficient information 51 includes a plurality of different kinds of attributes Z1 to Z5. Each of the attributes Z1 to Z5 has a priority rank. The kinds of attributes include a gender, an age, a generation, a weekly day off, a family configuration, a hobby, and a residential area. For instance, the kind of attribute Z1 indicates the generation, and the generation includes a plurality of categories of teens or lower, twenties, thirties, forties, fifties, and sixties or higher. FIG. 14 shows attribute coefficients respectively for users UA, UH, UI, UJ, and UK belonging to the same category of the generation. In this example, attribute coefficients “1.5”, “1.5”, “1.2”, “2.0”, and “1.2” are set respectively for the users UA, UH, UI, UJ, and UK. The attribute coefficient setting part 204B sets the attribute coefficient information 51 in advance. The attribute coefficient setting part 204B sets the attribute coefficient information 51 on the basis of, for example, household job data 31, 32 about a plurality of users in a predetermined period. As a first example, the attribute coefficient setting part 204B may set a larger attribute coefficient for a user having a larger household job amount within the most recent one month in accordance with a difference in household job amount. This attains an improvement in a motivation of a user having a larger household job amount. As a second example, the attribute coefficient setting part 204 may set a larger attribute coefficient for a user having a smaller household job amount within the most recent month in accordance with a difference in household job amount. This attains an improvement in a motivation of a user having a smaller household job amount. Here, all the users may have different attribute coefficient values from each other, or a part of the user may have an identical attribute coefficient value.

The attribute coefficient setting part 204B may set the attribute coefficient for each category of the plurality of categories included in the attribute. In this case, the attribute coefficient setting part 204B sets an identical attribute coefficient for the users belonging to the same category. For instance, regarding the attribute Z1 of the generation, the attribute coefficient is set for each age range, and an identical attribute coefficient is set for users belonging to the same age range. The attribute coefficient setting part 204B may set a larger attribute coefficient for an age range having a larger average value of household job amounts in a collecting period, or may set a larger attribute coefficient for an age range having a smaller average value of household job amounts in the collecting period. The attribute coefficient setting part 204B selects, in accordance with a kind of attribute, either a first way of setting different attribute coefficients among users belonging to the same category or a second way of setting different attribute coefficients among a plurality of categories included in an attribute. Information about the selection is included in the attribute coefficient information 51. The first way is selected in connection with the weekly day off, the family configuration, or the hobby, and the second way is selected in connection with the gender, the age, the generation, or the residential area.

Next, in step SP104, the processing part 202 calculates a household job point that is commensurate with a household job amount of each user on the basis of the household job data 31 and the attribute coefficient information 51 to generate household job point information 42B.

As a first example, in the calculation of the household job point, the processing part 202 may use two or more attribute coefficients of the attribute coefficients in connection with attributes Z1 to Z5 in combination. For instance, regarding the user UA, the attribute coefficient “1.5” in connection with the attribute Z1 in the first priority rank is multiplied by the attribute coefficient “1.1” in connection with the attribute Z2 in the second priority rank to use the resultant attribute coefficient “1.65”. When the number of users belonging to the same attribute group indicates a permissible upper limit value or higher, the processing part 202 can limit the number of users belonging to the same attribute group by increasing the number of attribute coefficients to be combined in accordance with the priority rank.

As a second example, in the calculation of the household job point, the processing part 202 may use one attribute coefficient selected from the attribute coefficients in connection with attributes Z1 to Z5. The processing part 202 basically uses the attribute coefficient in connection with the attribute Z1 in the first priority rank. When one of the attribute coefficients in connection with attributes Z2 to Z5 is more suitable than the attribute coefficient in connection with the attribute Z1, the processing part 202 selects the attribute coefficient in connection with any one of the attributes Z2 to Z5 in accordance with the priority rank. For instance, in a case where an increase in a household job point is smaller than a second value regardless of an increase in a household job amount of a certain user by a first value or larger in a current collecting period of household job data 31 in comparison with a previous collecting period thereof, the processing part 202 selects an attribute coefficient such that an increase in the household job point reaches the second value or larger.

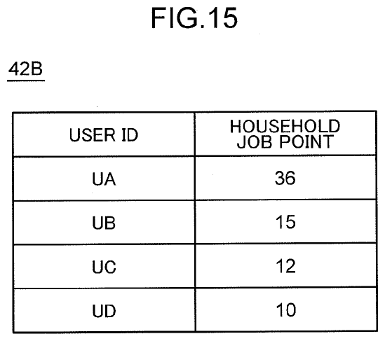

FIG. 15 is a table showing an example of simplified household job point information 42B generated on the basis of the household job data 31 and the attribute coefficient information 51. Regarding the household job point information 42B, the attribute coefficient shown in FIG. 14 is multiplied by the household job point included in the household job point information 41 shown in FIG. 6 to calculate the household job point for each user. For instance, regarding the user UA, the attribute coefficient “1.5” in connection with the attribute Z1 shown in FIG. 14 is multiplied by the household job point “24” shown in FIG. 6 to calculate the household job point as “36”.

The output part 203 outputs the household job point information 42B generated by the processing part 202. The user can obtain privileges like the privileges described in the first embodiment in accordance with the given household job point.

In the embodiment, calculation of a household job point on the basis of the household job data 31 and the attribute coefficient information 51 leads to achievement in appropriate giving of a household job point that is commensurate with the household job amount of each user.

### First Modification

An attribute coefficient may be determined or changed by a specific user defined in advance. The specific user having a change authority inputs change information indicating a change content of the attribute coefficient from a communication device 17 or an integrated controller 16. An acquisition part 201 acquires the change information via a communication network 12. An attribute coefficient setting part 204B changes the attribute coefficient on the basis of the change information acquired by the acquisition part 201, and stores the changed attribute coefficient information 51 in a storage part 112. Thereafter, calculation of a household job point is executed by using the changed attribute coefficient information 51.

The specific user may change the attribute coefficient of a user unconditionally or within a range in which a total value of attribute coefficients of all the users or the household job points for the users reaches an upper limit or lower. For instance, an attribute coefficient larger than usual may be set for a user having executed a household job in response to an irregular event, such as a sudden visit of an unexpected visitor. The attribute coefficient setting part 204B may set, as the specific user, a user having the largest household job amount within the most recent predetermined period (e.g., one week, one month, or a couple of months) on the basis of the household job data 31 about the predetermined period. An information processing device 11 may transmit a change notification to a communication device 17 owned by a target user whose attribute coefficient has been changed to cause the communication device 17 to display, on a screen thereof, such a message as to motivate the user to do the household job.

### Second Modification

An attribute coefficient may be changed in accordance with a cumulative value of household job data 31, 32. An attribute coefficient setting part 204B calculates a cumulative household job amount (frequency or time) of a user on the basis of household job data 31, 32, and changes the attribute coefficient of the user on the basis of the calculated cumulative amount. The attribute coefficient setting part 204B stores changed attribute coefficient information 51 in a storage part 112, and thereafter, executes calculation of a household job point on the basis of the changed attribute coefficient information 51.

For instance, the attribute coefficient setting part 204B may set an attribute coefficient having a first value for household job data having less than a predetermined cumulative household job amount (e.g., ten times), and set an attribute coefficient having a second value which is larger than the first value for household job data having the predetermined cumulative household job amount or larger. Contrarily, the attribute coefficient setting part 204B may set an attribute coefficient having a first value for household job data having less than a predetermined cumulative household job amount, and set an attribute coefficient having a second value which is smaller than the first value for household job data having the predetermined cumulative household job amount or larger. One of the first value and the second value may be identical among a plurality of users.

### Third Modification

An attribute coefficient may be changed in accordance with a timeframe in which a household job is executed. An attribute coefficient setting part 204B specifies, on the basis of timeframe information included in use information 20, a timeframe in which a household job is executed, and changes the attribute coefficient in accordance with the timeframe.

For instance, the attribute coefficient setting part 204B may divide twenty four hours in a day into a first timeframe from 0:00 to 12:00, a second timeframe from 12:00 to 18:00, and a third timeframe from 18:00 to 24:00, and then set an attribute coefficient for each user to a different value depending on the timeframe. For instance, the attribute coefficient may be set to a larger value in the order of the first timeframe, the second timeframe, and the third timeframe, or the attribute coefficient may be set to a smaller value in the order of the first timeframe, the second time, and the third timeframe. The attribute coefficient setting part 204B may set the attribute coefficient to a different value in accordance with the number of users staying in a smart home 2 for each timeframe. For instance, the attribute coefficient may be set to a larger value for a smaller number of users staying in the smart home.

### Fourth Modification

An attribute coefficient may be changed in accordance with a content of a household job. In a case where the number of users having executed a specific household job (which is called a disliked household job) is smaller than a predetermined value within the most recent collecting period of household job data 31, an attribute coefficient setting part 204B changes the attribute coefficient of a user having executed the household job to increase by a predetermined value or a predetermined proportion. The attribute coefficient setting part 204B stores changed attribute coefficient information 51 in a storage part 112, and thereafter, executes calculation of a household job point on the basis of the changed attribute coefficient information 51.

### Fifth Modification

A user may not be limited to an individual and may represent a group such as a family. In this case, the attribute coefficient setting part 204B sets an identical attribute coefficient per group.

### Sixth Modification

A kind of attribute may include holding information about an IoT appliance held by a user. The holding information may include the number of held appliances or a kind of each appliance. In this case, an attribute coefficient setting part 204B sets an identical attribute coefficient for a plurality of users having the same or similar number of held IoT appliances, or the same or similar kind thereof.

Conclusively, the embodiment can solve the drawback of new stress feeling which may occur as a result of continuous comparison between users in different environments. Specifically, a business operator that can collect household job data and attribute information about a user achieves visualization of a household job amount by using the household job data and the attribute information through information processing by a computer. This succeeds in solving the drawback.

The present disclosure is particularly useful for a home control system including a smart home adopting the IoT technologies.

1. A household job point calculation method, comprising:
by an information processing device,
acquiring use information indicating a use situation of an appliance or a facility;
collecting household job data of each of a plurality of users on the basis of the use information;
acquiring user coefficient information indicating a user coefficient for each of the users; and
calculating, on the basis of the household job data and the user coefficient information, a household job point that is commensurate with a household job amount of each of the users.

2. The household job point calculation method according to claim 1, further comprising setting the user coefficient for each of the users on the basis of the household job data of the user in a predetermined period.

3. The household job point calculation method according to claim 2, wherein, in the setting of the user coefficient, a larger user coefficient is set for a user having a larger household job amount in the predetermined period.

4. The household job point calculation method according to claim 2, wherein,
in the setting of the user coefficient, a larger user coefficient is set for a user having a smaller household job amount in the predetermined period.

5. The household job point calculation method according to claim 1, further comprising:
acquiring change information indicating a change in the user coefficient from a specific user of the users; and
changing the user coefficient on the basis of the change information.

6. The household job point calculation method according to claim 5, further comprising setting the specific user on the basis of the household job data of the users in a predetermined period.

7. The household job point calculation method according to claim 1, further comprising:
calculating a cumulative household job amount of each of the users; and
changing the user coefficient of the user on the basis of the cumulative household job amount of the user.

8. The household job point calculation method according to claim 1, further comprising changing the user coefficient in accordance with a timeframe in which a household job is executed.

9. The household job point calculation method according to claim 1, wherein the use information includes first use information about use of the appliance or the facility accompanied by execution of a household job, and second use information about use of the appliance or the facility unaccompanied by the execution of the household job, and,
in the collecting of the household job data, the household job data is collected on the basis of the first use information.

10. The household job point calculation method according to claim 1, further comprising acquiring evaluation coefficient information indicating an evaluation coefficient in connection with an evaluation of a household job executed by each of the users, wherein,
in the calculating of the household job point, the household job point is calculated on the basis of the household job data, the user coefficient information, and the evaluation coefficient information.

11. A household job point calculation method, comprising:
by an information processing device,
acquiring use information indicating a use situation of an appliance or a facility;
collecting household job data of a user on the basis of the use information;
acquiring attribute coefficient information indicating an attribute coefficient in connection with an attribute of the user; and
calculating, on the basis of the household job data and the attribute coefficient information, a household job point that is commensurate with a household job amount of the user.

12. The household job point calculation method according to claim 11, further comprising setting an attribute coefficient for each of a plurality of users on the basis of household job data of the users in a predetermined time period, the users belonging to a specific same category of a plurality of categories included in the attribute.

13. The household job point calculation method according to claim 12, wherein,
in the setting of the attribute coefficient, a larger attribute coefficient is set for a user having a larger household job amount in the predetermined period.

14. The household job point calculation method according to claim 12, wherein,
in the setting of the attribute coefficient, a larger attribute coefficient is set for a user having a smaller household job amount in the predetermined period.

15. The household job point calculation method according to claim 11, further comprising setting an attribute coefficient for each of a plurality of categories included in the attribute, wherein,
in the setting of the attribute coefficient, an identical attribute coefficient is set for a plurality of users belonging to a specific same category.

16. The household job point calculation method according to claim 11, wherein the attribute coefficient information includes a plurality of attribute coefficients in connection with a plurality of kinds of attributes.

17. The household job point calculation method according to claim 16, wherein,
in the calculating of the household job point, two or more attribute coefficients of the attribute coefficients are used in combination.

18. The household job point calculation method according to claim 16, wherein,
in the calculating of the household job point, one attribute coefficient selected from the attribute coefficients is used.

19. The household job point calculation method according to claim 11, further comprising:
acquiring change information indicating a change in the attribute coefficient from a specific user; and
changing the attribute coefficient on the basis of the change information.

20. The household job point calculation method according to claim 19, further comprising setting the specific user on the basis of household job data of a plurality of users in a predetermined period.

21. The household job point calculation method according to claim 11, further comprising:
calculating a cumulative household job amount of the user; and
changing the attribute coefficient on the basis of the cumulative household job amount of the user.

22. The household job point calculation method according to claim 11, further comprising changing the attribute coefficient in accordance with a timeframe in which a household job is executed.

23. The household job point calculation method according to claim 11, wherein the use information includes first use information about use of the appliance or the facility accompanied by execution of a household job, and second use information about use of the appliance or the facility unaccompanied by the execution of the household job, and,
in the collecting of the household job data, the household job data is collected on the basis of the first use information.

24. An information processing device, comprising:
an acquisition part; and
a processing part, wherein
the acquisition part acquires use information indicating a use situation of an appliance or a facility,
the processing part collects household job data of each of a plurality of users on the basis of the use information,
the acquisition part acquires user coefficient information indicating a user coefficient for each of the users, and
the processing part calculates, on the basis of the household job data and the user coefficient information, a household job point that is commensurate with a household job amount of each of the users.

25. An information processing device, comprising:
an acquisition part; and
a processing part, wherein
the acquisition part acquires use information indicating a use situation of an appliance or a facility,
the processing part collects household job data of a user on the basis of the use information,
the acquisition part acquires attribute coefficient information indicating an attribute coefficient in connection with an attribute of the user, and
the processing part calculates, on the basis of the household job data and the attribute coefficient information, a household job point that is commensurate with a household job amount of the user.

26. A computer-readable recording medium recording a program causing an information processing device to serve as an acquisition part and a processing part, wherein
the acquisition part acquires use information indicating a use situation of an appliance or a facility,
the processing part collects household job data of each of a plurality of users on the basis of the use information,
the acquisition part acquires user coefficient information indicating a user coefficient for each of the users, and
the processing part calculates, on the basis of the household job data and the user coefficient information, a household job point that is commensurate with a household job amount of each of the users.

27. A computer-readable recording medium recording a program causing an information processing device to serve as an acquisition part and a processing part, wherein
the acquisition part acquires use information indicating a use situation of an appliance or a facility,
the processing part collects household job data of a user on the basis of the use information,
the acquisition part acquires attribute coefficient information indicating an attribute coefficient in connection with an attribute of the user, and
the processing part calculates, on the basis of the household job data and the attribute coefficient information, a household job point that is commensurate with a household job of the user.
